(19) United States
(12) Patent Application Publication
(10) Pub. No.: US 2008/0000650 A1
(43) Pub. Date: Jan. 3, 2008

(54) Cooking appliance

(75) Inventor: Sung Ho Choi, Daegu City (KR)

Correspondence Address: KED & ASSOCIATES, LLP, P.O. Box 221200, Chantilly, VA, 20153-1200, US

(73) Assignee: LG Electronics Inc.

(21) Appl. No.: 11/819,591

(22) Filed: Jun. 28, 2007

(30) Foreign Application Priority Data
Jun. 30, 2006 (KR) 2006-0060943

(51) Int. Cl. A62C 3/00

(52) U.S. Cl. 169/65; 219/679

(57) ABSTRACT

Disclosed are a cooking appliance for constantly monitoring a risk of fire in the same and nearby appliances, and a fire control method using the same. The cooking appliance comprises a casing forming an appearance of the cooking appliance. A fire sensing unit is disposed on one wall of the casing. The sensing unit senses an indoor state or an internal state of the casing. A notifying unit is disposed in the casing for notifying a pre-specified terminal of current information. A control unit is disposed in the casing for comparing sensed information from the fire sensing unit with previously stored reference information to determine whether a fire occurs and controlling the notifying unit according to the determination result.

### CROSS-REFERENCE TO RELATED APPLICATION

This application claims the benefit of Korean Patent Application No. 10-2006-60943, filed Jun. 30, 2006, the disclosure of which is hereby incorporated herein by reference in its entirety.

### BACKGROUND OF THE INVENTION

1. Technical Field

The present invention relates to a cooking appliance, and more particularly, to a cooking appliance capable of automatically coping with a fire upon sensing the fire, and a method of controlling the same.

2. Discussion of Related Art

In general, a cooking appliance cooks food using supplied gas or electricity. Examples of the cooking appliance include a microwave range, an oven range, and the like.

The microwave range cooks food using microwave, and the oven range cooks food using either an electrical heater or a gas burner.

Recently, hybrid type cooking appliance has been introduced, such as a modern hybrid electric oven range that cooks food using microwave and/or high-temperature heat.

The conventional cooking appliance has a higher risk of a fire than other home appliances.

Accordingly, a scheme of sensing fire occurrence inside a cooking chamber of a cooking appliance using a sensor for sensing the internal temperature of the cooking chamber was developed.

However, the scheme can sense only the fire occurrence in a specific cooking appliance, not in other cooking appliance or household appliance in a kitchen. Accordingly, the scheme cannot actively cope with the fire occurrence in an indoor area.

In particular, when a fire is detected, the user is notified of the occurrence of the fire if the user is in the indoor area only. When the user is not in the indoor area, he or she is not notified of the fire occurrence.

### SUMMARY OF THE INVENTION

An aspect of the present invention provides a cooking appliance and a method of controlling the cooking appliance, which is capable of continuously checking whether or not there is a fire in other cooking appliances around the cooking appliance of the present invention as well as in the relevant cooking appliance, and notifying a user and other fire-related offices of the fire when it occurs.

Exemplary embodiments of the present invention provide a cooking appliance comprising: a casing forming an appearance of the cooking appliance; a fire sensing unit disposed on one wall of the casing for sensing an indoor state or an internal state of the casing; a notifying unit disposed in the casing for notifying a pre-specified terminal of current information; and a control unit disposed in the casing for comparing said information with previously stored reference information to determine whether a fire occurs and controlling the notifying unit according to the comparing result.

The fire sensing unit may comprise at least one of a temperature sensor for sensing an indoor temperature or an internal temperature of the casing, and a smoke sensor for sensing an indoor smoke amount based on optical transmittance.

The notifying unit may comprise a communication module connected to the Internet or a network for transmitting information data.

The pre-specified terminal may comprise at least one among a control server of a fire station, a portable terminal of a user, and a terminal of a fire-related company or fire manager.

The control unit may comprise a memory for storing said reference information and an identification of the specified terminal.

The memory may be disposed in a protection casing, and the protection casing is made of a fire-resistant material.

The casing may be a casing of an over the range (OTR), and the fire sensing unit may be disposed on a bottom of the casing.

The cooking appliance may further comprise an extinction material tank disposed in the casing for storing an extinction material including extinction liquid or extinction powder; and a spraying unit for selectively spraying the extinction material stored in the extinction material tank under control of the control unit. The casing may be a casing of an over the range (OTR), and the spraying unit may be disposed on a bottom of the casing.

Other embodiments of the present invention provide a method of controlling a cooking appliance comprising the steps of: sensing an indoor state or an internal state of a casing; comparing the sensed state information with reference information stored in a memory to determine whether a fire occurs; and when it is determined that the fire occurs, controlling a notifying unit to notify a pre-specified terminal of fire occurrence.

The state information sensed in the sensing step may comprise a time related temperature parameter and a time related smoke amount parameter.

The state information sensed in the sensing step may comprise a time related temperature parameter and a time related smoke amount parameter, and the determining step may determine that the fire occurs when both the time-specific temperature and the time-specific smoke amount have abnormal values in comparison with the reference information stored in the memory. The method may further comprise specifying a time when the determination is made as a fire occurrence time and storing it in the memory when it is determined that the fire occurs.

The notifying step may comprise transmitting a message to the specified terminal through the Internet or a network. The message may comprise a fire occurrence time, the sensed state information, and address information.

The method may further comprise an initial extinction step of spraying an extinction material stored in an extinction material tank when it is determined that the fire occurs.

The method may further comprise the step of performing the sensing step and the determining step again to determine whether the fire is extinguished after performing the initial extinction step. The method may further comprise the step of re-notifying, by the notifying unit, a pre-specified terminal of a result of determining whether the fire is extinguished.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating a cooking appliance according to a first embodiment of the present invention;

FIG. 2 is a schematic block diagram illustrating a cooking appliance according to the first embodiment of the present invention;

FIG. 3 illustrates indoor state information stored in a memory of a cooking appliance according to the first embodiment of the present invention;

FIG. 4 is a flowchart illustrating a method of controlling a cooking appliance according to the first embodiment of the present invention;

FIG. 5 is a schematic block diagram illustrating a cooking appliance according to a second embodiment of the present invention; and

FIG. 6 is a perspective view illustrating the cooking appliance according to the second embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention.

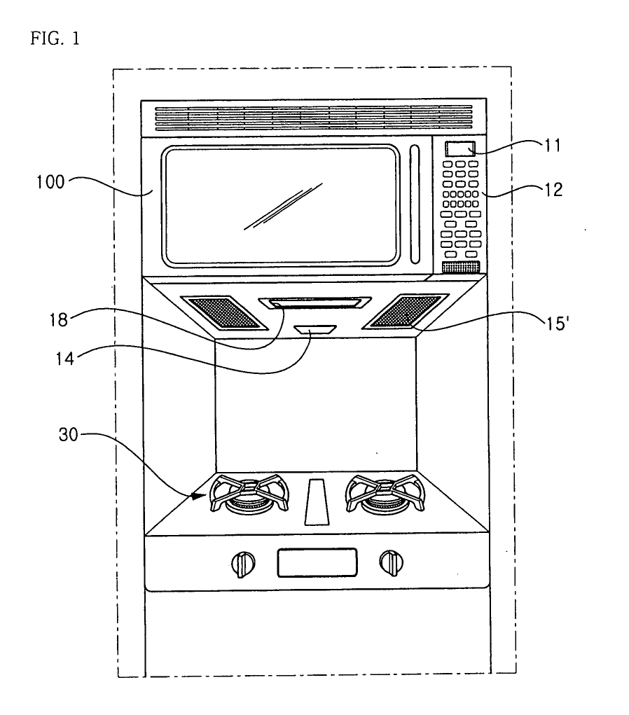

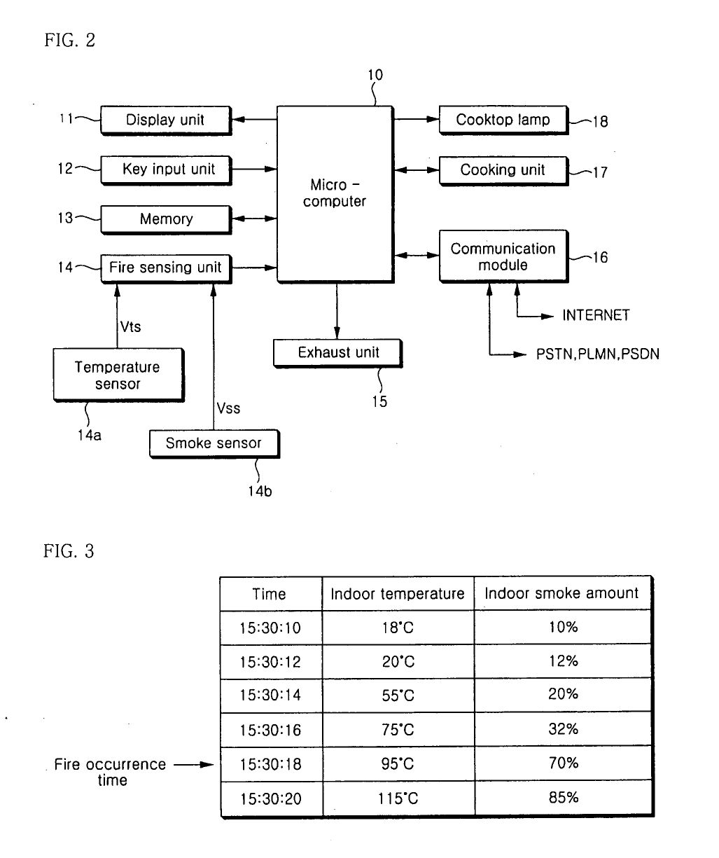

FIGS. 1 and 2 show a cooking appliance according to a first embodiment of the present invention.

In the first embodiment of the present invention, the cooking appliance is an over the range (OTR). The OTR is a hybrid electric oven range disposed over other cooking appliance such as a gas range (hereinafter, referred to as a “lower cooking appliance”) 30, for inhaling smoke and heat generated from the lower cooking appliance 30 and exhausting them to the exterior.

The cooking appliance according to the first embodiment of the present invention comprises a casing 100, a fire sensing unit, a notifying unit, and a control unit.

Specifically, the casing 100 forms the appearance of the cooking appliance.

The casing 100 comprises an exhaust unit. The exhaust unit comprises an inlet 15′ and an exhaust duct (not shown).

The inlet 15′ is formed on a bottom of the casing 100 for inhaling smoke and heat from the lower cooking appliance 30 disposed under the casing 100. The exhaust duct extends along the inside of the casing 100 and exhausts the smoke and heat inhaled through the inlet 15 to the exterior.

A cooktop lamp 18 is disposed on the bottom of the casing 100 for illuminating the lower cooking appliance 30, and a display unit 11 and a key input unit 12 are disposed on a front of the casing 100. Preferably, the display unit 11 may be a thin film transistor liquid crystal display (TFT-LCD) for displaying a cooking menu and an operation state using a variety of colors on a high-resolution screen.

The key input unit 12 receives a cooking command, a menu setting command, and the like from a user and sends them to the control unit 10. The key input unit 12 comprises a cooking key, a move key or dial for selecting a cooking method or a menu, and functional cooking keys for activating cooking operation according to a previously-programmed cooking method.

The cooking appliance further comprises a cooking unit 17 disposed inside the casing 100 for heating food in the cooking chamber to perform the cooking operation.

The cooking unit 17 comprises at least one among a magnetron and a heater. The cooking unit 17 further comprises a fan, sensors, and a turntable. The cooking unit is controlled by the control unit 10.

The fire sensing unit 14 senses an indoor state or an internal state of the casing 100.

The fire sensing unit 14 is disposed on one wall of the casing 100. The fire sensing unit 14 comprises at least one among a temperature sensor 14a and a smoke sensor 14b.

The temperature sensor 14a senses an indoor temperature or an internal temperature of the casing 100. The temperature sensor 14a consists of a variable resistor whose resistance varies with temperature. The temperature sensor 14a provides a temperature sense signal Vts at a voltage level dependent on the indoor temperature, to the control unit 10.

The smoke sensor 14b senses an amount of the smoke by the method of detecting optical transmittance. The smoke sensor 14b sends a smoke sense signal Vss to the control unit 10.

In particular, in the first embodiment of the present invention, the fire sensing unit 14 is disposed on the bottom of the casing 100. This is because the cooking appliance according to the embodiment of the present invention is an over the range and a fire is highly likely to occur in the lower cooking appliance 30.

The notifying unit notifies a previously-specified terminal (hereinafter, referred to as a “specified terminal”) of the information sensed by the fire sensing unit 14 and fire-related information.

The notifying unit is disposed inside the casing 100. The notifying unit comprises a data communication module 16 connected to a network such as the Internet, a public switching telephone network (PSTN), a public land mobile network (PLMN), a public switching data network (PSDN), or the like, for transmitting information.

In particular, examples of the specified terminal include at least one among a control server of a fire station, a portable terminal of a user, and a terminal of a fire-related company or a fire manager. The specified terminal may be a portable terminal capable of wired/wireless communication (e.g., a portable telephone or a personal digital assistant (PDA)), or a computer.

The communication module 16 is programmed to transmit the sensed information and the fire-related information as a text message using a short message service (SMS).

The control unit 10 compares the sensed information with previously-stored reference information to determine whether a fire occurs, and controls the communication module 16 according to the comparing result to transmit the fire occurrence to each specified terminal.

Preferably, the control unit 10 is disposed in an electronic-part mounting section (a space for various electronic parts and a microcomputer) of the casing 100.

In particular, in the embodiment of the present invention, the control unit 10 is a microcomputer for controlling various cooking operations of the cooking appliance.

The control unit 100 further comprises a memory 13. The memory 13 stores reference information needed for determination as to fire occurrence, identifications of specified terminals, cooking modes and menus, cooking information of the menus, indoor state information (e.g., temperature, smoke amount, and time) received from the fire sensing unit 14, etc.

The reference information refers to a threshold of an indoor temperature (e.g., about 90° C.) and an indoor smoke amount (e.g., about 70%) considered as fire occurrence. The identification includes a telephone number or an Internet Protocol (IP).

In particular, the memory 13 is located in a protection casing (not shown) that is made of a fire-resistant material. Preferably, the memory 13 may be used as a fire black box for enabling a user to check the situation when a fire occurs. Of course, the memory 13 itself may be made of a fire-resistant material and the entire control unit 10 may be located in the protection casing.

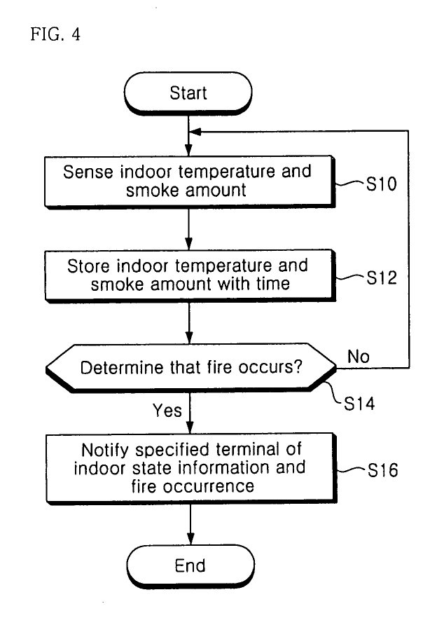

A method of controlling the cooking appliance according to the embodiment of the present invention configured as described above will now be described with reference to a flowchart of FIG. 4.

First, the control unit 10 continues to sense an indoor state (particularly, a state of the space in which the lower cooking appliance is disposed) or an internal state of the casing 100 by controlling the fire sensing unit 14 (S10).

The state information from the fire sensing unit 14 includes a time related temperature parameter and a time related smoke amount parameter.

The temperature sensor 14a of the fire sensing unit 14 provides a temperature sense signal Vts to the control unit 10, and the smoke sensor 14b of the fire sensing unit 14 provides a smoke sense signal Vss to the control unit 10.

The temperature sense signal Vts indicates resistance varying with an indoor temperature, and the smoke sense signal Vss indicates optical transmittance.

The control unit 10 continues to convert the received signals into a temperature value and a smoke amount and store them in the memory 13 according to a time (S12).

The control unit 10 checks the temperature sense signal Vts received from the temperature sensor 14a and the smoke sense signal Vss varying with time, and compares the signals to the reference information stored in the memory 13 to determine whether a fire occurs (S14).

In other words, the control unit 10 compares the indoor temperature and the smoke amount received from the sensors 14a and 14b with the reference information according to the time, and determines that a fire occurs when both the indoor temperature and the smoke amount have abnormal values (i.e., exceed the reference information, i.e., reference values).

For example, it is assumed that the reference information for the indoor temperature is set to 90° C. and the reference information for the indoor smoke amount is set to 70%. The indoor temperature and the indoor smoke amount are continuously monitored as shown in FIG. 3. When the indoor temperature sensed by the sensor 14a of the fire sensing unit 14 is 95° C. and the indoor smoke amount sensed by the sensor 14b is 70%, it is determined that the fire occurs and a determination time is stored as a fire occurrence time in the memory 13.

If either the indoor temperature or the indoor smoke amount is smaller than the reference information, it is determined that the fire does not occur. This is intended to maximally prevent mis-determination as to fire occurrence.

After the determination as to fire occurrence is made through the above processes, the control unit 10 controls the communication module 16 to notify the specified terminal indicated by the information in the memory 13 of fire occurrence (S16).

Examples of the specified terminal include a control server of a fire station, a portable terminal of a user, and a terminal of a fire-related company or a fire manager (e.g., a fire manager responsible for the fire-occurred house), as described previously.

The fire notification is made by transmitting a message to the specified terminal through the Internet or network.

The message includes a fire occurrence time, a timerelated indoor temperature parameter and a timerelated smoke amount parameter stored in the memory 13, and address information of a fire place.

Preferably, even after the fire occurrence is notified, the information on the indoor state is continuously obtained by the fire sensing unit 14, stored in the memory 13, and periodically notified to the specified terminal. This minimizes an error of fire detection and enables the fire station, the user, the fire-related company, or the fire manager to continuously check the current state.

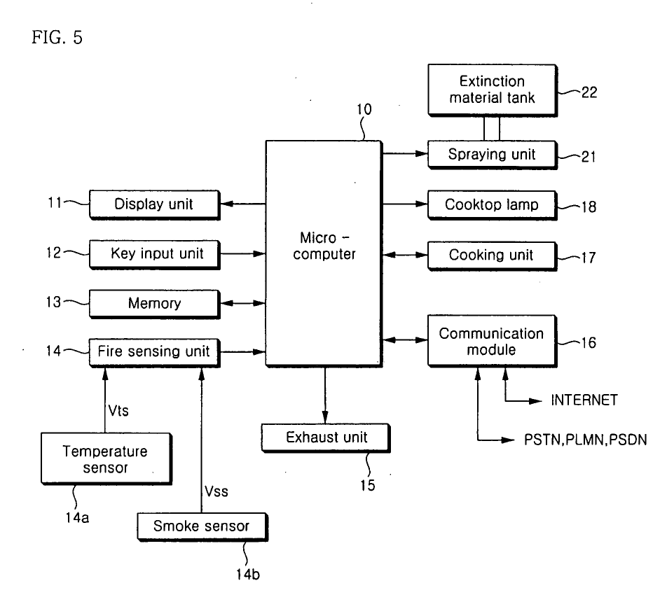

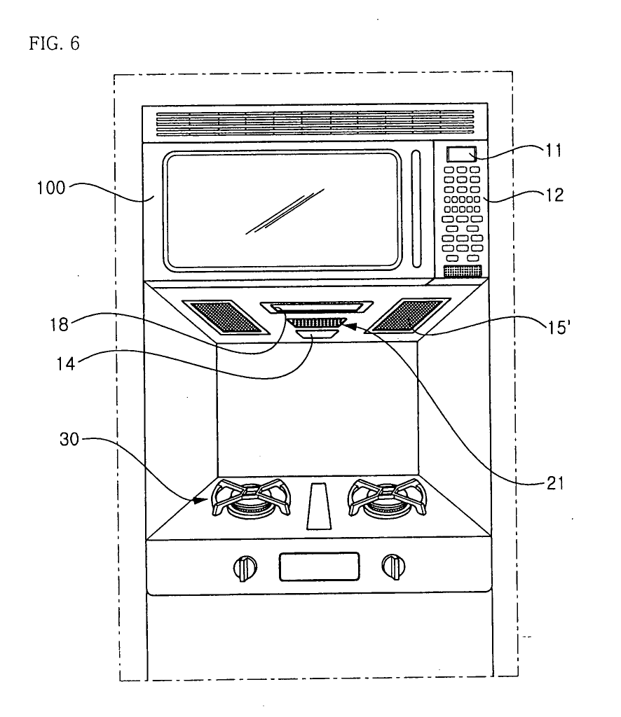

FIG. 5 is a schematic block diagram illustrating a cooking appliance according to a second embodiment of the present invention, and FIG. 6 is a view illustrating the cooking appliance according to the second embodiment of the present invention.

In the second embodiment of the present invention, the cooking appliance further comprises a unit for initial extinction upon firing.

Specifically, the cooking appliance further comprises an extinction material tank 22 and a spraying unit 21 disposed inside the casing 100, as shown in FIG. 5. The spraying unit 21 is controlled by the control unit 10 so that initial extinction is possible upon firing.

The extinction material tank 22 stores an extinction material such as extinction liquid or extinction powder, and the spraying unit 21 is a nozzle coupled with the extinction material tank 22.

In particular, in the second embodiment of the present invention, the spraying unit 21 is disposed on the bottom of the casing 100, as shown in FIG. 6.

A method of controlling the cooking appliance according to the second embodiment of the present invention is substantially the same as that described according to the first embodiment of the present invention except the following. When a fire occurs, the control unit 10 controls the spraying unit 21 to spray the extinction material stored in the extinction material tank 22 in an initial extinguishing process.

After the initial extinguishing process is performed, the fire sensing process by the fire sensing unit 14 and the fire occurrence determining process by the control unit 10 are preferably performed again to determine whether the fire has been extinguished. When the fire has been extinguished, this fact may be re-notified to the specified terminal via the communication module 16.

The cooking appliance according to the present invention is not limited to the OTR microwave oven as explained in the first and second embodiments.

For example, the fire sensing unit, communication module, extinction material tank and spraying unit according to the present invention are applicable to a conventional microwave oven or oven range.

If the fire control means, including the fire sensing unit, communication module, fire extinction material tank and spraying unit, according to the present invention are applied to a conventional microwave oven or oven range, it will be preferable to mount those fire control means on an outer side wall, top or front wall of the microwave oven or oven range.

The cooking appliance and the method of controlling the cooking appliance according to the present invention have the following advantages.

First, the indoor temperature and the smoke amount are detected, the determination is made as to whether a fire occurs based upon the detected information, and the fire occurrence is rapidly notified to the specified terminal. Thus, a large fire can be prevented in advance.

Second, the accurate fire state and fire occurrence time can be provided. Thus, causes of the fire can be recognized accurately.

Third, the memory of the cooking appliance is configured to withstand the fire. Thus, an indoor state at the time of firing can be accurately recognized after the fire is extinguished.

Fourth, initial extinction is performed upon firing. Thus, the fire can be early extinguished and fire spread can be delayed maximally.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A cooking appliance comprising:
a casing forming an appearance of the cooking appliance;
a fire sensing unit disposed on one wall of the casing for sensing an indoor state or an internal state of the casing;
a notifying unit disposed in the casing for notifying a pre-specified terminal of current information; and
a control unit disposed in the casing for comparing said information with previously stored reference information to determine whether a fire occurs and controlling the notifying unit according to the comparing result.

2. The cooking appliance according to claim 1, wherein the fire sensing unit comprises at least one among a temperature sensor for sensing an indoor temperature or an internal temperature of the casing, and a smoke sensor for sensing an indoor smoke amount based on optical transmittance.

3. The cooking appliance according to claim 1, wherein the notifying unit comprises a communication module connected to the Internet or a network for transmitting information data.

4. The cooking appliance according to claim 1, wherein the pre-specified terminal comprises at least one among a control server of a fire station, a portable terminal of a user, and a terminal of a fire-related company or fire manager.

5. The cooking appliance according to claim 1, wherein the control unit comprises a memory for storing said reference information and an identification of the specified terminal.

6. The cooking appliance according to claim 5, wherein the memory is located within a protection casing, the protection casing being made of a fire-resistant material.

7. The cooking appliance according to claim 1, wherein the casing is a casing of an over the range (OTR), and the fire sensing unit is disposed on a bottom of the casing.

8. The cooking appliance according to claim 1, further comprising:
an extinction material tank disposed in the casing for storing an extinction material including extinction liquid or extinction powder; and
a spraying unit for selectively spraying the extinction material stored in the extinction material tank under control of the control unit.

9. The cooking appliance according to claim 8, wherein the casing is a casing of an over the range (OTR) and the spraying unit is disposed on a bottom of the casing.

10. A cooking appliance comprising:
a fire sensing unit for sensing an indoor state;
a memory for storing the sensed indoor state information and previously-set indoor reference information;
a control unit for comparing the sensed indoor information with the previously-set indoor reference information to determine whether a fire occurs; and
a notifying unit for notifying a pre-specified terminal of the indoor state information and fire occurrence according to the signal of the control unit.

11. A method of controlling a cooking appliance comprising the steps of:
sensing an indoor state or an internal state of a casing;
comparing the sensed state information with reference information stored in a memory to determine whether a fire occurs; and
controlling a notifying unit to notify a pre-specified terminal of fire occurrence.

12. The method according to claim 11, wherein the state information sensed in the sensing step comprises a time related temperature parameter or a time related smoke amount parameter.

13. The method according to claim 11, wherein the state information sensed in the sensing step comprises a time related temperature parameter or a time related smoke amount parameter, and
the determining step determines by the comparing between the state information and the stored reference information.

14. The method according to claim 13, further comprising specifying a time when the determination is made as a fire occurrence and storing it in the memory when it is determined that the fire occurs.

15. The method according to claim 11, wherein the notifying step comprises transmitting a message to the specified terminal through the Internet or a network.

16. The method according to claim 15, wherein the message comprises at least one among the fire occurrence time, the sensed state information, and address information.

17. The method according to claim 11, further comprising an initial extinction step of spraying an extinction material stored in an extinction material tank when it is determined that the fire occurs.

18. The method according to claim 17, further comprising the step of performing the sensing step and the determining step again to determine whether the fire is extinguished after performing the initial extinction step.

19. The method according to claim 18, further comprising the step of re-notifying, by the notifying unit, a pre-specified terminal of a result of determining whether the fire is extinguished.
